(19) United States
(12) Patent Application Publication
(10) Pub. No.: US 2009/0183473 A1
(43) Pub. Date: Jul. 23, 2009

(54) Universal frame for use with a fabric filter

(76) Inventor: Wing-kin Hui, Hong Kong (HK)

Correspondence Address: PENINSULA IP GROUP, 26150 BUCKS RUN, CORRAL DE TIERRA, CA, 93908, US

(21) Appl. No.: 12/016,429

(22) Filed: Jan. 18, 2008

(51) Int. Cl. B01D 46/02

(52) U.S. Cl. 55/378

(57) ABSTRACT

Disclosed herein is a structure for a frame filter, which is adaptable for a wide variety of different housing. The frame filter in accordance with the instant invention includes a universal frame and a housing and fabric filter bag secured between the two members. The frame is rigid and in combination with the housing forms a clamping member to secure the filter bag between for rugged use including movement and shocking-type motion. The frame, in accordance with this invention, defines a picture frame having a central opening defined by an annulus. The frame includes clamping structure for attaching the fabric filter bag to the frame and the housing of an appliance. A wide variety of shapes are within the spirit and scope of the structure of the invention.

### FIELD OF THE INVENTION

This invention generally relates to the field of fabric filters. More particularly, this invention relates to a structure for enabling a fabric filter to be easily and effectively used by a consumer on a variety of different appliances where the fabric filter includes a rigid frame.

### BACKGROUND OF THE INVENTION

Fabric filters are useful in many different situations. For example, pool cleaners use a fabric filter. Different pool cleaners have different sized and shaped fabric filters. Periodically, the fabric filter needs to be changed or replaced. Typically, the user needs to order an entire new unit including the filter bag. Indeed some manufacturers only make a filter cartridge and each time the filter needs to be replaced an entirely new cartridge must be used.

Additionally, fabric filter are used in industrial cleaning situations. For example, in clean room settings, cleaners with fabric filters are used almost exclusively.

In order to make it simple and economical for consumers to replace their filters, a substitute filter structure is needed wherein the filter bag can be easily and efficiently replaced. Additionally, such a structure should be easily adapted to wide variety of appliances which use fabric filter bags regardless of the irregularity or uniformity of each such shape required by the particular appliance.

### SUMMARY OF THE INVENTION

The structure in accordance with the invention is a rigid universal frame, which can be adapted and contoured for use with a variety of different appliance housings. The structure of the invention further includes a housing and a fabric filter, such as a filter bag. The rigid frame defines a picture frame having a central opening defined by an annulus. The frame in combination with the housing provides a clamping structure which secures the filter there between.

It is an object of this invention to provide a rigid filter frame for a fabric filter which is adaptable to be contoured for a variety of different appliances.

It is an additional object of this invention to provide such a filter frame which is easy to change and easy to replace.

In accordance with one exemplary embodiment of the filter frame in accordance with this invention, the structure comprises:

a frame member, the frame being rigid and having an annulus with a central opening center;

a housing member;

a fabric filter held securely between the frame and the housing;

the frame and the housing including compatible clamping means for securely holding the frame and housing together;

the clamping means removeably securing the housing and frame members together with the fabric filter held between the members;

and the housing adapted for connection to an appliance.

Additionally, in another exemplary embodiment, the means for attaching the frame to the housing includes the frame having a female clamping member and the housing having a male clamping member. The female clamping member is force fit over the male clamping member with the fabric filter between the two members.

In an exemplary embodiment of the fabric filter in accordance with the instant invention, the fabric filter is passed through the central opening and wrapped around the inside of the frame. The filter passes over the female clamping member and the excess filter portion hangs outside the circumference of the annulus. The frame including the filter is passed over the male clamping member and secured thereto by means of a force fit between the members.

In various other embodiments, the housing may define regular or irregular shapes and forms. In all cases the frame is sized and shaped to be adapted to be secured to the housing with the fabric filter in place.

It is an advantage of this invention to provide such a fabric filter frame which is adaptable to a wide variety of different appliances and which is easy to replace the fabric filter.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective view of the frame filter in accordance with this invention.

FIGS. 2 & 3 are sectional views illustrating the connection of the fabric filter and the frame and housing of the frame filter in accordance with this invention.

FIGS. 4-6 illustrate various embodiments of the frame filter in accordance with this invention.

### DETAILED DESCRIPTION OF THE INVENTION

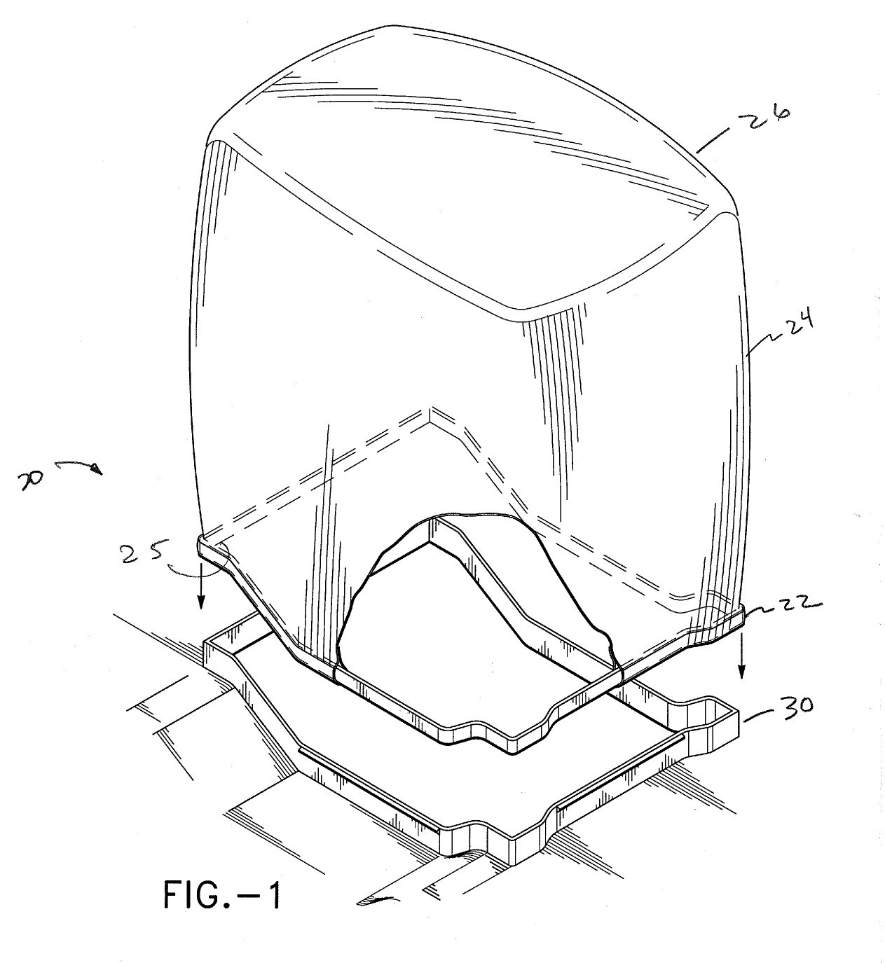

An exemplary embodiment of the filter frame 20 in accordance with the present invention generally denoted by the numeral 20 will now be described with reference to FIG. 1. The frame filter 20 in accordance with the instant invention includes a universal frame 22 and a fabric filter bag 24. The frame 22 and bag 24 are connected to a housing 30 for securing the bag thereto.

As seen in FIGS. 1-3, the fabric filter 20 has an open end 25 and a closed end 26. The open end 25 is wrapped around the frame 22. The frame 22 is rigid and withstand considerable pressure. In the exemplary embodiment shown in FIGS. 1-3, the fabric filter open end 25 is wrapped around the inside of frame 22. The excess portion of the fabric filter bag 24 curls over the frame 22.

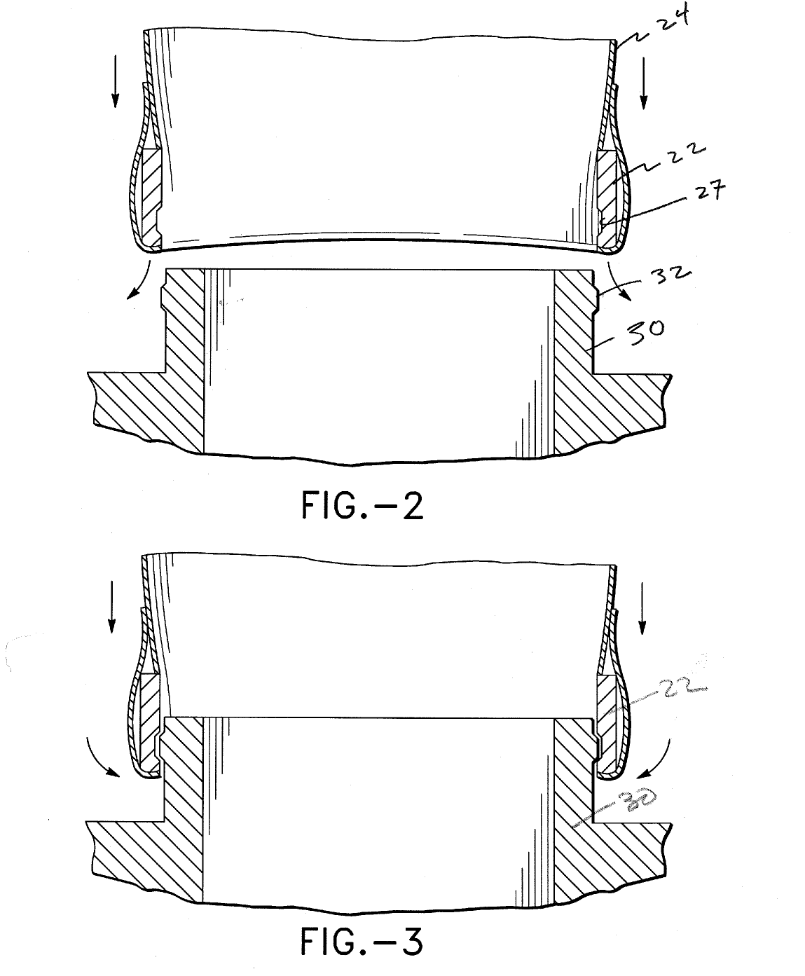

As seen most clearly in FIGS. 2 & 3, the inside portion of the frame 22 has a female member comprising part of the means for securing the frame 22 to a housing 30 designated by the numeral 27. The housing 30 has a male member 32 which provides a compatible force fit with the female member 27. Once the fabric filter 24 is wrapped around the frame 22, it is secured thereto by force fitting the frame 22 over the housing 30.

As will be appreciated, the combination of the male and female members, 27 and 32, respectively, define a clamping member. The clamping member is designed to withstand considerable movement and even shaking without losing its secure hold of the filter bag 24. This allows the frame filter 20 of the instant invention to be adaptable for a variety of situations. It even allows the frame filter 20 to be used under quite adverse and difficult conditions where keeping the filter bag 26 secured to the housing 30 is an issue.

In an exemplary embodiment, the inside portion of the frame 22 defines an annulus 40. The annulus 40 has a recessed area 42, which defines a raceway around the circumference of the frame 22. In the same exemplary embodiment, the housing 30 includes male members 44 which compatibly fit within the raceway and secure the frame 22 to the housing 30. Clearly, when the filter bag 24 is wrapped around the housing 24 using the same technique earlier described, the filter bag 24 is secured to the housing 30 and the advantages described above apply equally to this embodiment as well.

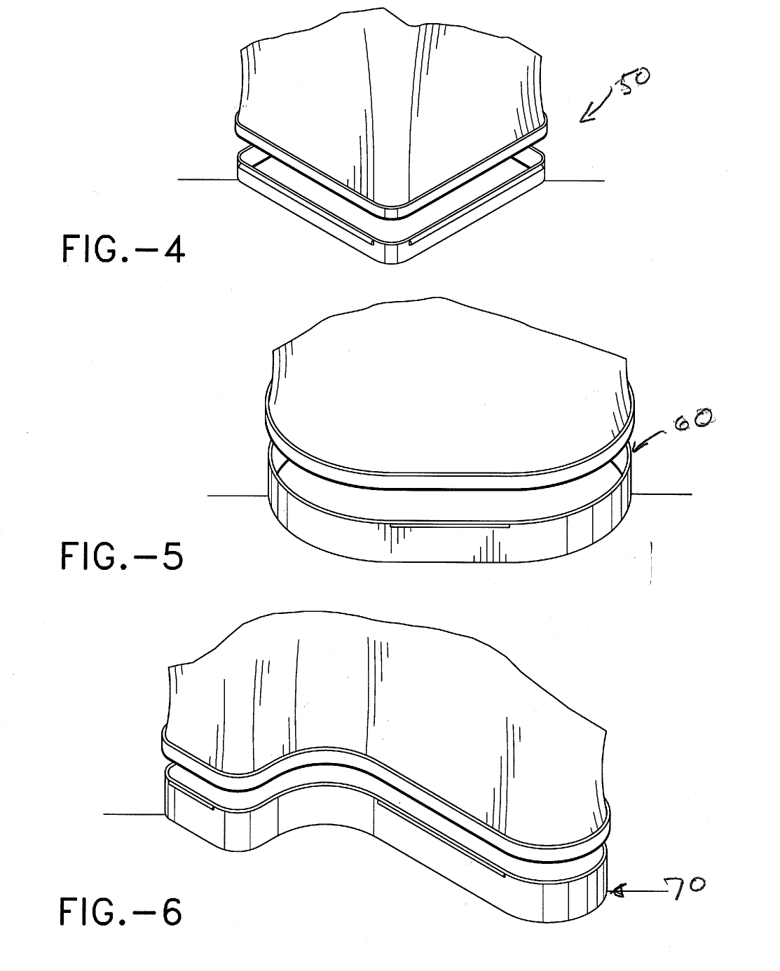

FIGS. 4-6 illustrate the ability of the frame filter in accordance with this invention to be adapted to various configurations of housings and frames. This allows the frame filter to be used a wide variety of appliances within the spirit and scope of the invention. With particular reference to FIG. 4, there is shown another exemplary embodiment of the frame filter in accordance with the invention, generally denoted by the numeral 50. In this embodiment, the frame filter comprises a generally square and uniform shape. In all other respects, the elements and members of the frame filter are the same as the embodiments discussed above.

With particular reference to FIG. 5, there is shown another exemplary embodiment of the frame filter in accordance with the invention, generally denoted by the numeral 60. In this embodiment, the frame filter comprises a generally round and uniform shape. In all other respects, the elements and members of the frame filter are the same as the embodiments discussed above.

With particular reference to FIG. 6, there is shown another exemplary embodiment of the frame filter in accordance with the invention, generally denoted by the numeral 70. In this embodiment, the frame filter comprises a generally irregular curved shape. In all other respects, the elements and members of the frame filter are the same as the embodiments discussed above.

While the foregoing detailed description has described several embodiments of the fabric filter frame in accordance with this invention, it is to be understood that the above description is illustrative only and not limiting of the disclosed invention. Particularly, there can be a variety of different clamping structures and means of wrapping the filter around the frame that are all within the spirit and scope of this invention. It will be appreciated there are also various frame and housing shapes are well with the scope and spirit of the invention and the specific shapes set forth in the exemplary embodiments discussed above are illustrative only and that there are numerous other shapes and sizes that are not mentioned but which are well within the scope and spirit of this invention. Thus, the exemplars of the invention discussed above, are illustrative only and the invention itself is to be limited only by the claims as set forth below.

What is claimed is:

1. A fabric filter frame for use with a fabric filter and adaptable to an appliance, the fabric filter comprising:
a frame member, the frame member being rigid and having an annulus with a central opening center;
a housing member;
a fabric filter held securely between the frame and the housing;
the frame and the housing including compatible clamping means for securely holding the frame and housing together;
the clamping means removeably securing the housing and frame members together with the fabric filter held between the members;
and the housing adapted for connection to an appliance.

2. The frame of claim 1, wherein the annulus includes a raceway defining a female clamping member and the housing including compatible a male member for being force fit into the raceway with the fabric filter between he members.

3. The frame of claim 1, wherein the frame defines a picture frame type central opening.

4. The frame of claim 1, wherein the fabric filter is wrapped around the frame annulus and wherein the annulus if force fit over the housing for removeably securing the housing and frame together with the fabric filter there between.

5. The frame of claim 4, wherein the fabric filter is wrapped around the inside of the annulus.

6. The frame of claim 1, wherein the housing is a regular shape defining a rectangle.

7. The frame of claim 1, wherein the housing is a regular shape defining a square.

8. The frame of claim 1, wherein the housing is a generally uniform shape approximating a circle.

9. The frame of claim 1, wherein the housing is a irregular angular shape.

10. The frame of claim 1, wherein the housing is a irregular curved shape.
